(19) United States
(12) Patent Application Publication
(10) Pub. No.: US 2021/0382176 A1
(43) Pub. Date: Dec. 9, 2021

(54) Distance measuring device and method for synchronizing field-of-view thereof

(71) Applicant: Namuga Co., Ltd., Gyeonggi-do (KR)

(72) Inventors: Jun Youb LEE, Gyeonggi-do (KR); Young Gyu KANG, Gyeonggi-do (KR); Jeong Hwa SEO, Gyeonggi-do (KR)

(73) Assignee: Namuga Co., Ltd., Gyeonggi-do (KR)

(21) Appl. No.: 17/336,848

(22) Filed: Jun. 2, 2021

(30) Foreign Application Priority Data
Jun. 3, 2020 (KR) 10-2020-0066762
Oct. 7, 2020 (KR) 10-2020-0129291

(51) Int. Cl. G01S 17/894; G02B 27/64; G02B 5/02; G01S 7/481

(52) U.S. Cl. CPC G01S 17/894; G01S 7/4817; G02B 5/0263; G02B 27/646

(57) ABSTRACT

An embodiment may provide a method for synchronizing a field of view of a distance measuring device including: a light source including one or more light source elements; and a light diffusion device through which light emitted from the light source passes, wherein the light diffusion device is divided into one or more regions, each of the light source elements of the light source is disposed with an independent region, and the intensity of light transferred from the light source elements is adjustable. The method may include: identifying a field of view (FOV) of a red, green, and blue (RGB) camera; and adjusting, based on a predetermined reference, the field of view of the distance measuring device such that the field of view of the distance measuring device corresponds to the field of view of the RGB camera.

### CROSS REFERENCE TO RELATED APPLICATION

This application claims the benefit of Korean Patent Applications Nos. 10-2020-0066762, filed on Jun. 3, 2020 and 10-2020-0129291, filed on Oct. 7, 2020, which are both hereby incorporated by reference for all purposes as if fully set forth herein.

### BACKGROUND

### Field of the Invention

The present disclosure relates to a distance measuring distance and a method for synchronizing the field of view of a distance measuring device, wherein the field of view of the distance measuring device is adjusted based on the field of view of an RGB camera.

### Description of the Prior Art

Typical examples of methods for identifying three-dimensional information include a stereo vision type, a structured-light type, and a time-of-flight type.

According to the time-of-flight (TOF) type, a laser having a predetermined pulse is repeatedly generated, and the time of arrival of the pulse after being reflected by an object is calculated, thereby measuring the distance.

The TOF-type method, unlike the stereo vision type, includes an additional process in which an object is scanned by a beam from a transmitter, and a light source thus needs to be included. In addition, a beam needs to be radiated at a predetermined angle such that light from the light source reaches the object appropriately, and various light diffusion devices are proposed to this end. Specifically, various light diffusion devices, which are epitomized by a diffuser and a prism, may be utilized to appropriately adjust the beam angle.

A conventional light diffusion device typically uses a predetermined type of diffuser or prism, and the radiation angle is determined according to the characteristics of the surface formed at the time of manufacturing. In this case, a beam is delivered to the object according to the initially configured radiation angle, regardless of the distance between the object and the light source. This causes a problem in that detectable regions are limited, and the delivery efficiency is degraded in proportion to the distance from the center of the beam during the beam scanning process. Furthermore, conventional light diffusion devices have a limitation in that, since each device uses a single light diffusion device, it is impossible to adjust the angle such that various radiation angles are available.

In addition, both a distance measuring device and an RGB camera are necessary to obtain both depth information and color image information by a device (for example, a smartphone). However, there is a problem in that the distance measuring device can provide depth information but no color image information, and the RGB camera can provide color image information but no depth information. Therefore, if the RGB camera and the distance measuring device are separately provided, an information processing device normally obtains color image information and depth information separately and then processes them separately.

If color image information and depth information from the RGB camera and the distance measuring device are separately processed as described above, each piece of data cannot be utilized appropriately. Such a problem worsens if color information of an object measured by the RGB camera and depth information of the object obtained by the distance measuring device have different references. If the measured field of view is constantly changed by movements of the light diffusion device of the distance measuring device, synchronization between color image data and depth data becomes more critical.

### SUMMARY

In this background, it is an aspect of the present disclosure to provide a distance measuring device and a method for synchronizing the field of view of a distance measuring device, wherein the field of view of a distance measuring device including a light source circuit and a light diffusion device is adjusted by identifying the field of view of an RGB camera.

A first embodiment may provide a distance measuring device including: a substrate; a light source which is electrically connected to the substrate, wherein an intensity of light outputted from the light source is adjustable; a light diffusion device configured to change an optical path of an output light from the light source; and an actuator configured to make a spatial movement of the light diffusion device, wherein the movement of the light diffusion device corresponds to a field of view (FOV) of an RGB camera.

In connection with the distance measuring device, a current generated while the actuator is driven is transferred to an image sensor in the distance measuring device to obtain distance data.

In connection with the distance measuring device, the RGB camera may further include a telephoto lens, and the field of view of the RGB camera may be changed according to a movement of the telephoto lens.

In connection with the distance measuring device, the light diffusion device may include a first light diffusion device and a second light diffusion device. The first light diffusion device may be connected to a first support fixed to the substrate and may change the optical path of the output light. The second light diffusion device may change a path of light transferred from the first light diffusion device. The actuator may include a coil, a piezoelectric element, or a rotation device. The second light diffusion device may comprise a magnet or a metal material which interacts with the actuator to make a movement in a direction of an optical path or in a direction perpendicular or parallel to the optical path. The movement made by the interaction between the second light diffusion device and the actuator allows adjusting a radiation angle or a direction of light.

In connection with the distance measuring device, the distance measuring device may measure a current or a voltage generated from the interaction between the second light diffusion device and the actuator to adjust the field of view of the distance measuring device.

In connection with the distance measuring device, the distance measuring device may further include a processor. The processor may acquire information about the field of view of the RGB camera and make a movement of the actuator depending on the information about the field of view of the RGB camera.

In connection with the distance measuring device, the processor may control the field of view of the RGB camera and calculate a movement distance of the light diffusion device and a field of view of the distance measuring device corresponding to the field of view of the RGB camera.

In connection with the distance measuring device, the processor may calculate an amount of a change in the field of view of the RGB camera, and generate a distance control signal for adjusting the movement distance of the light diffusion device according to the amount of a change in the field of view of the RGB camera.

The distance measuring device may further include an image sensor configured to receive reflected light from a subject to acquire distance data.

In connection with the distance measuring device, the processor may compare data measured by an image sensor of the RGB camera with data measured by the image sensor of the distance measuring device to adjust the field of view of the distance measuring device.

In connection with the distance measuring device, the image sensor may select data of only a partial region of the image sensor and control the field of view of the distance measuring device.

The distance measuring device may further include a light diffusion device configured to adjust a focal length of a lens through which the reflected light to be transferred to the image sensor passes.

In connection with the distance measuring device, the processor may compare distance data measured by the distance measuring device with color image data measured by the RGB camera to generate three-dimensional data.

In connection with the distance measuring device, the processor may match the distance data measured by the distance measuring device to the color image data measured by the RGB camera for each position to generate three-dimensional data.

A second embodiment may provide a method for synchronizing a field of view of a distance measuring device including: a light source including one or more light source elements; and a light diffusion device through which light emitted from the light source passes, wherein the light diffusion device is divided into one or more regions, each of the light source elements of the light source is disposed to have an independent region, and an intensity of light transferred from the light source elements is adjustable, the method including: identifying a field of view (FOV) of a red, green, and blue (RGB) camera; and adjusting, based on a predetermined reference, the field of view of the distance measuring device such that the field of view of the distance measuring device corresponds to the field of view of the RGB camera.

The method for synchronizing a field of view of a distance measuring device may further include transferring, to an image sensor, a current generated while the field of view of the distance measuring device is adjusted such that the field of view of the distance measuring device corresponds to the field of view of the RGB camera.

In connection with the method for synchronizing a field of view of a distance measuring device, the light diffusion device may comprise a first light diffusion device and a second light diffusion device. The first light diffusion device may let light emitted from the light source pass and may be connected to a first support. The first light diffusion device may be surrounded by a body. The body may include a coil or a piezoelectric element. The first light diffusion device may comprise a magnet or a metal material which interacts with the body to make a movement in a direction of an optical path or in a direction perpendicular to the optical path. The movement made by the interaction between the first light diffusion device and the body allows adjusting a radiation angle or a direction of light. The light source may respectively adjust output lights of the light source elements.

A third embodiment may provide a system comprising: an RGB camera configured to acquire two-dimensional data of a subject; and a distance measuring device configured to acquire distance data of the subject, wherein the distance measuring device includes: a light source configured to output light; a light diffusion device configured to change a path of light transferred from the light source and to reduce an intensity of the light; an actuator configured to make a movement of the light diffusion device through interaction between a coil and an electromagnet disposed therein; and a processor configured to calculate a field of view of the RGB camera to control a movement of the actuator.

In connection with the system, the light diffusion device may include a first light diffusion device and a second light diffusion device. The actuator may change a relative distance between the first light diffusion device and the second light diffusion device.

In connection with the system, the processor may plot a movement of the actuator corresponding to the field of view of the RGB camera to form a lookup table and may change the field of view of the distance measuring device based on the lookup table.

As described above, according to the present disclosure, a distance measuring device can accurately calculate a distance with efficient power consumption.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a distance measuring device including multiple light diffusion devices;

FIG. 2 illustrates a distance measuring device including one light diffusion device;

FIG. 3 illustrates a change in the field of view according to a distance to an object;

FIG. 4 is a schematic view illustrating a method for synchronizing the field of view of a distance measuring device on the basis of the field of view of an RGB camera;

FIG. 5 illustrates a first embodiment of an RGB camera;

FIG. 6 illustrates a second embodiment of an RGB camera;

FIG. 7 illustrates a first embodiment of a distance measuring device;

FIG. 8 illustrates a second embodiment of a distance measuring device;

FIG. 9 illustrates the comparison of the field of view of a distance measuring device and the field of view of an RGB camera;

FIG. 10 illustrates a first embodiment of a second receiver of a distance measuring device;

FIG. 11 illustrates a cross section of a second receiver of a distance measuring device;

FIG. 12 illustrates a first embodiment of a control device;

FIG. 13 illustrates a second embodiment of a control device;

FIG. 14 illustrates the comparison of a first receiver region of an RGB camera and a second receiver region of a distance measuring device; and

FIG. 15 is a flowchart illustrating a method for synchronizing the field of view of a distance measuring device.

### DETAILED DESCRIPTION OF THE EXEMPLARY EMBODIMENTS

Hereinafter, some embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

In addition, terms, such as first, second, a, b or the like may be used herein when describing elements of the present disclosure. These terms are merely used to distinguish one element from other elements, and a property, an order, a sequence and the like of a corresponding element are not limited by the terms. It should be noted that if it is described in the specification that one element (a first element) is “connected”, “coupled”, or “joined” to another element (a second element), a third element may be “connected”, “coupled”, and “joined” between the first and second elements, although the first element may be directly connected, coupled or joined to the second element.

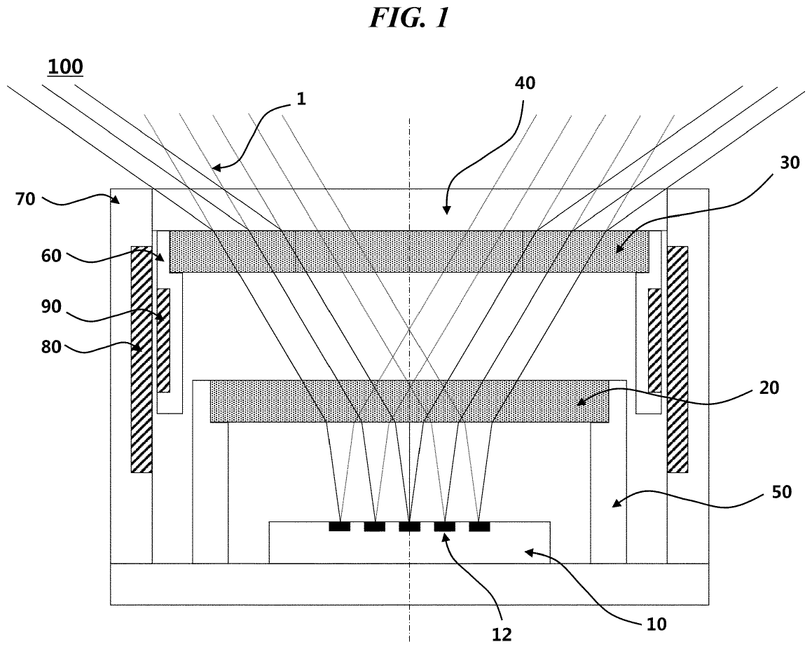

FIG. 1 illustrates a distance measuring device including multiple light diffusion devices.

Referring to FIG. 1, a distance measuring device 100 may include a first diffuser 20, a second diffuser 30, a cover 40, a supporter 50, an adjuster 60, a body 70, a coil 80, and a magnet 90.

The first diffuser 20 may be fixed by the supporter 50, and may diffuse light transferred from a light source 10 including a light source element 12. A concave and convex portion formed on the surface of the first diffuser 20 may have various shapes, and may be made of various materials. An angle for diffusing light may be variously configured due to the above-described shapes, materials, or the like. If necessary, the first diffuser 20 may be defined as a first light diffusion device.

For example, a light diffusion device may be a various types of optical elements, such as a diffuser, a diffractive optic element (DOE), a microlens array, a collimator lens, a Fresnel lens, or the like.

The intensity, optical path, or the like of light passing a light diffusion device may be changed, and the reduced intensity of light or the changed optical path may be differently defined depending on design conditions such as the type and thickness of a light diffusion device.

When the path of light passing through a light diffusion device is changed, the angle of light finally emitted may be defined as the field of view (FOV), but is not limited thereto.

The second diffuser 30 may be fixed by the adjuster 60, and may diffuse light, which has passed through the first diffuser, at a predetermined radiation angle. A concave and convex portion formed on the surface of the second diffuser 30 may have various shapes, and may be made of various materials. An angle for diffusing light may be variously configured due to the above shapes, materials, or the like. If necessary, the second diffuser 30 may be defined as a second light diffusion device.

The body 70 is coupled to the cover 40, and the coil 80 may be formed in the body 70.

The coil 80 may adjust the distance between the first diffuser and the second diffuser through interaction with the magnet 90 fixed in the adjuster 60.

If necessary, the adjuster 60 and the body 70 may be defined as an actuator, and the actuator may receive a control signal from a control device (not shown) and may generate movement of the light diffusion device.

The control device (not shown) may control an output of a predetermined region of the light source element 12. If necessary, in the control device, a processor may be adopted.

The light source element 12 may form a light source chip, and at least one light source element may be disposed so as to be electrically connected to a substrate. For example, if the light source element 12 is a vertical cavity surface emitting laser (VCSEL), multiple VCSELs may be included.

The region of the light source element 12 may be configured as and divided into a first region and a second region, and the output of the first region and the output of the second region may be separately adjusted by the control device (not shown).

The output of the second region, among the configured regions of the light source element 12, may be adjusted to be lower than the output of the first region.

The light source 10 may include a first light source and a second light source.

The first light source of the light source 10 may be formed as a vertical cavity surface emitting laser (VCSEL) element.

The second light source of the light source 10 may have a wider beam angle than the first light source.

The optical paths in FIG. 1 are illustrated for describing a change in the field of view, and thus are not limited thereto and may have various forms according to the shape, placement, or the like of a lens.

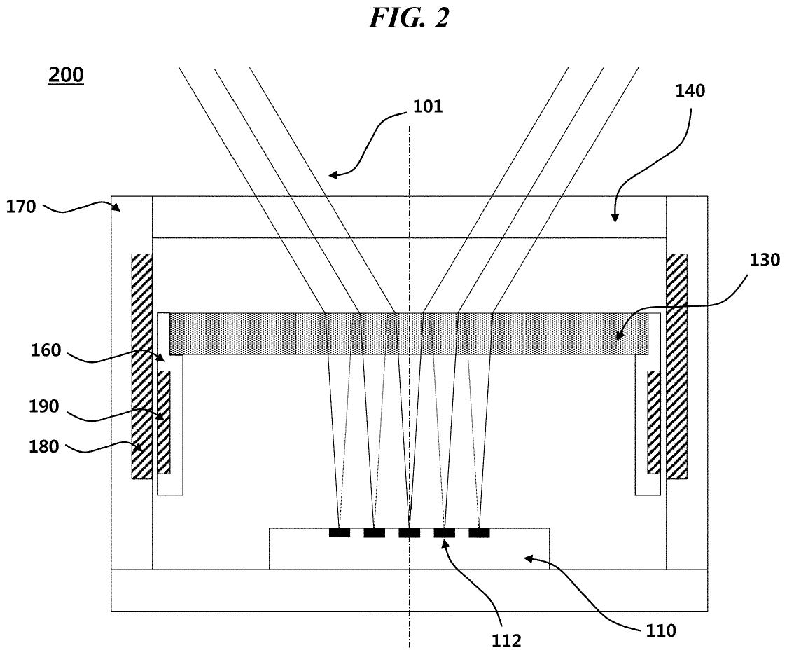

FIG. 2 illustrates a distance measuring device including one light diffusion device.

Referring to FIG. 2, a distance measuring device 200 may include a diffuser 130, a cover 140, an adjuster 160, a body 170, a coil 180, and a magnet 190.

The diffuser 130 may be fixed by the adjuster 160, and may diffuse light, which has passed through the diffuser 130, at a predetermined radiation angle. A concave and convex portion formed on the surface of the diffuser 130 may have various shapes, and may be made of various materials. An angle for diffusing light may be variously configured due to the above shapes, materials, or the like.

The body 170 is coupled to the cover 140, and the coil 180 may be formed in the body 170.

The coil 180 may adjust the distance between the diffuser 130 and a light source 110 through interaction with the magnet 190 fixed in the adjuster 160.

A light source element 112 may form a light source chip, and at least one light source element may be included. For example, if the light source element 112 is a vertical cavity surface emitting laser (VCSEL), multiple VCSELs may be included.

A control device (not shown) may control the output of configured regions of the light source element 112. Further, the control device (not shown) may be electrically connected to an actuator and at least on camera so as to control driving thereof.

The region of the light source element 112 may be configured as and divided into a first region and a second region, and the output of the first region and the output of the second region may be separately adjusted by the control device (not shown).

The output of the second region, among the configured regions of the light source element 112, may be adjusted to be lower than the output of the first region.

The light source 110 may include a first light source and a second light source.

The first light source of the light source 110 may be formed as a vertical cavity surface emitting laser (VCSEL) element.

The second light source of the light source 110 may have a wider beam angle than the first light source.

The position of each of the diffuser 130, the adjuster 160, and the magnet 190 may be adjusted upward and downward.

The distance between the diffuser 130 and the light source 110 may be adjusted through interaction between the coil 180 and the magnet 190. More specifically, an electromagnetic force is generated by the coil 180 along which a current flows, and the distance between the diffuser 130 and the light source 110 is adjusted by interaction between the magnet 190 and the electromagnetic force. The accurate distance between the diffuser 130 and the light source 110 and the direction of movement thereof are determined based on the intensity and direction of the current, which flows along the coil 180. For example, the amplification of an electromagnetic field by the coil 180 may adjust the distance according to the piezoelectric effect (Piezo effect). The distance between the diffuser 130 and the light source 110 may be adjusted, and the direction of light 101, which has passed through the distance measuring device 200, may be finally determined.

The direction of the light 101 may be variously determined as diffusion angles for long distance or diffusion angles for a short distance according to a form of surface of the diffuser 130.

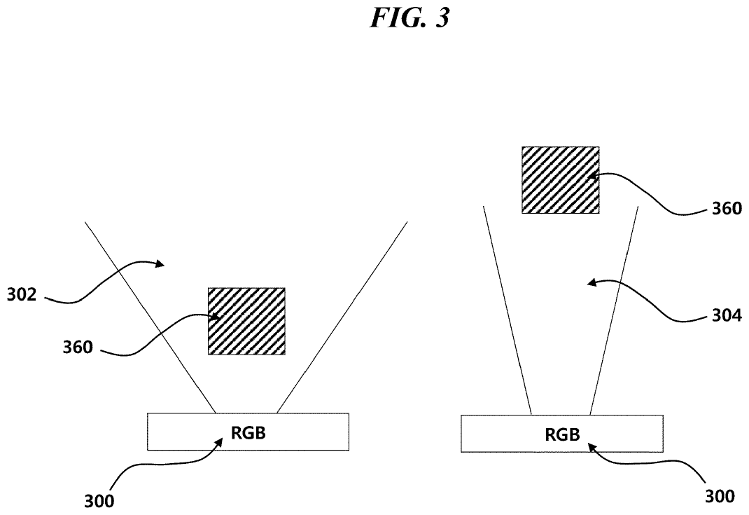

FIG. 3 illustrates a change in the field of view according to a distance to an object.

Referring to FIG. 3, an RGB camera 300 may adjust the diffusion region of light or the emission angle of light according to a distance to an object 360.

The RGB camera 300 may be a conventional camera which can acquire two-dimensional data of an object and three-color (red, green, blue) data.

The RGB camera 300 may be a camera having a standard field of view, a wide-angle camera with a diagonal field of view of 70-80 degrees or more, or the like, and at least one camera may be disposed and may be driven while being connected to a processor (not shown).

The RGB camera 300 may be a camera which includes a telephoto lens and a voice coil motor (VCM), wherein the telephoto lens moves according to the movement of a voice coil motor, a distant subject is magnified by various magnification factors, for example, by a factor of 3, a factor of 5, a factor of 10, etc., and then an image of the subject is acquired.

The RGB camera 300 may be a camera which can enlarge and acquire an image of a subject through an internal software program without a physical change in the position of a lens. The software program may crop data of a partial region of an image sensor so as to enlarge the image.

When a distance measuring device includes multiple RGB cameras 300, the field of view of each camera and the field of view of a ToF camera are not linked with each other, and thus there is an increasing need to adjust and synchronize the fields of view of all the cameras in real time by a processor (not shown).

The field of view (FOV) may have the same meaning as the term “angle of view (AOV)”. The field of view (FOV) is an angle at which a camera can capture an image through a lens, and if necessary, may imply a region in which the camera can capture an image.

If necessary, the field of view (FOV) may be defined based on the size of a region of light reaching an object or the distribution of light having an intensity equal to or larger than a predetermined reference intensity.

If necessary, the field of view (FOV) may be defined as beam divergence of a beam emitted from a light source.

Typically, the field of view (FOV) may be calculated using a focal length and the length of an image plane (film or sensor). For example, the field of view (FOV) may be calculated by

$$FOV = 2 {tan}^{- 1} ( \frac{K}{2 f} ) ,$$

but is not limited thereto (f: focal length, K: length of image plane (film or sensor)).

For example, the image plane implies the area of an element which plays the role of receiving light in a light collector of a camera, and various references such as a transverse length, a longitudinal length, or a diagonal length may be used as the length of an image plane.

An RGB camera according to an embodiment may include a telephoto lens, and may adjust the field of view (FOV) by using the telephoto lens. The telephoto lens may be a combination of lenses which is called a telephoto group extending the path of light in order to make a long focus lens. For example, the telephoto lens may include multiple lenses, and a device configured to adjust the distance between lenses may be adjusted as necessary. For example, the device configured to adjust the distance between lenses may be a voice coil motor (VCM) including a coil and a magnet, but is not limited thereto.

In order to adjust the distance between lenses or the direction thereof, as necessary, optical image stabilization (OIS) technology may be applied to additionally generate the movement of a light diffusion device or a lens, or a change in the direction thereof.

According to an embodiment, the field of view of the RGB camera may be adjusted to be a first field of view 302 or a second field of view 304. The field of view of the RGB camera may be adjusted by a telephoto lens or a device configured to adjust the field of view, and the type of the device configured to adjust the field of view is not limited. For example, a device configured to adjust the field of view of the RGB camera may be a telephoto lens.

Typically, when the object 360 is at a short distance, the field of view of the RGB camera is wider than when the object 360 is at a long distance. On the contrary, typically, when the object 360 is at a long distance, the field of view of the RGB camera is narrower than when the object 360 is at a short distance. A reference to determine whether the object is at a short distance or at a long distance may previously vary.

According to an embodiment, making the field of view narrow when an object is at a long distance is for the purpose of making light reaching the object less diffused and thus increasing the amount of light reaching the object. When the amount of light reaching the object increases, the amount of reflected light reaching an image sensor increases, and thus an image measured by the sensor may have a high resolution. When the amount of light reaching the sensor increases, noise may be less generated.

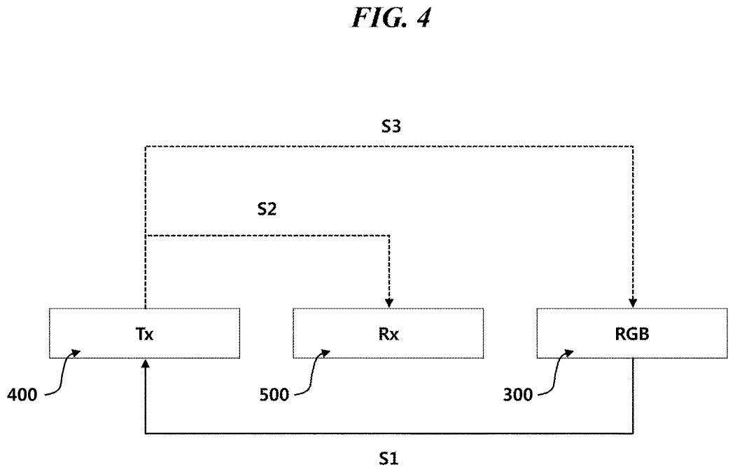

FIG. 4 is a schematic view illustrating a method for synchronizing the field of view of a distance measuring device on the basis of the field of view of an RGB camera.

Referring to FIG. 4, a method for synchronizing the field of view of a distance measuring device 400 according to an embodiment may adjust the field of view of the distance measuring device on the basis of the field of view of an RGB camera 300.

For convenience, the distance measuring device may be defined as Tx, a receiver of the distance measuring device may be defined as Rx, and the RGB camera may be defined as RGB.

If necessary, the distance measuring device configured to acquire object distance data and the RGB camera configured to acquire two-dimension data of the object may be defined as separate cameras, but may be integrated into a single system.

According to an embodiment, the method may include identifying the field of view of the RGB camera 300 and adjusting the field of view of the distance measuring device 400 (S1).

In the identifying of the field of view of the RGB camera 300, the field of view may be identified based on a current or a voltage in the RGB camera, the actual emission angle of light may be measured, or the field of view of light may be directly measured, but the identifying of the field of view of the RGB camera 300 is not limited thereto.

In the adjusting of the field of view of the distance measuring device 400, the field of view of the distance measuring device 400 may be adjusted based on a predetermined reference so as to correspond to the field of view of the RGB camera. The field of view of the distance measuring device 400 may be adjusted to be equal to the field of view of the RGB camera, but the predetermined reference may be differently determined based on the size, the placement, or the shape of the distance measuring device and the RGB camera. For example, the field of view of the RGB camera may be 30°, 50°, or 70°, and the field of view of the distance measuring device may also be adjusted to 30°, 50°, or 70°.

According to another embodiment, the distance measuring device 400 may include a second transmitter Tx, and may control a signal of the second transmitter on the basis of a predetermined reference of the distance measuring device 400 (S2). For example, the signal of the second transmitter may be a current, a voltage, an electric charge amount, or the like, but is not limited thereto.

Further, according to another embodiment, the distance measuring device 400 may control a signal of the RGB camera, based on a predetermined reference (S3). For example, the signal of the RGB camera may correspond to a current, a voltage, an electric charge amount, or the like, and may also correspond to the focal length of the RGB camera, the position of a lens, an output, or the like.

In FIG. 4, a description has been made of an example in which the field of view of a ToF camera 400 or 500 is controlled based on the field of view of the RGB camera 300, but an embodiment of the present disclosure is not limited thereto.

According to an embodiment, a processor (not shown) may transfer a signal for controlling the field of view, for example, a signal for generating the movement of an optical device of the RGB camera, to the RGB camera, and may sequentially transfer a signal for controlling the field of view, for example, a signal for generating the movement of an optical device of the ToF camera, to the ToF camera.

According to an embodiment, the processor (not shown) may simultaneously transfer a signal for controlling the field of view to the RGB camera and the ToF camera. In this case, it is possible to minimize the time needed to synchronize the field of view of the RGB camera and the field of view of the ToF camera.

According to an embodiment, the processor (not shown) may transfer a signal for controlling the field of view to the ToF camera and then may transfer a signal for controlling the field of view to the RGB camera.

According to an embodiment, when it is difficult to acquire distance data according to the movement of the optical device of the ToF camera (for example, actuation of the optical device due to a subject moving nearer or farther away), the processor (not shown) may perform control such that the output of a light source is adjusted. The output of the light source and the field of view of each of the RGB camera and the ToF camera may be controlled simultaneously or separately.

According to the embodiment, three-dimensional data may be accurately acquired regardless of a method for driving each camera, for example, a fixed focus method or an auto focus method.

Further, according to the embodiment, a driving mode of the ToF camera (for example, an intermediate-distance mode, a far-distance mode, or a near-distance mode) configured to acquire distance data may be changed in response to a change of various field of view of the RGB camera (for example, a normal field of view, a narrow field of view, or a wide field of view), and thus a more accurate three-dimensional distance map may be generated.

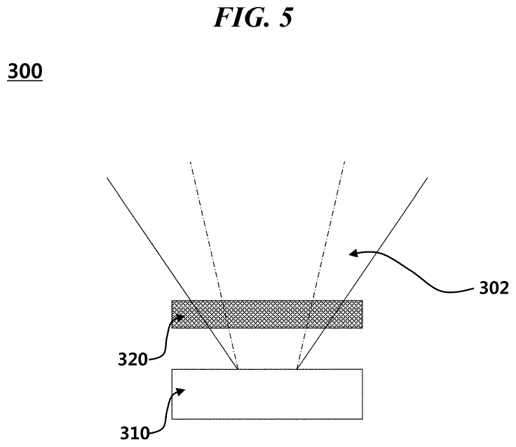

FIG. 5 illustrates a first embodiment of an RGB camera.

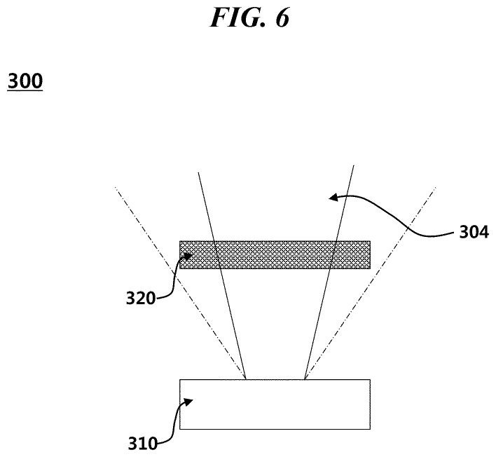

FIG. 6 illustrates a second embodiment of an RGB camera.

Referring to FIGS. 5 and 6, an RGB camera 300 may include a first transmitter 310, a first receiver (not shown), and a telephoto lens 320.

The first transmitter 310 plays the role of outputting light, but a conventional known light output device may be used if the same plays a role similar to that of the first transmitter 310. The output light may have a first field of view 302. The first field of view 302 may be adjusted based on the position of an object and the movement of the telephoto lens 320, but, when the object is at a short distance, the field of view (FOV) is typically configured to be larger than when the object is at a long distance. In contrast, when the object is at a long distance, the field of view (FOV) is typically configured to be smaller than when the object is at a short distance. When the field of view (FOV) is configured to be small, the amount of light reaching an object per unit area may be increased, and thus the resolution of an acquired image may be increased and noise may be reduced.

When light having reached the object through the first transmitter 310 is reflected and reached, the first receiver (not shown) may recognize the reflected light and may process a generated signal.

The telephoto lens 320 may include multiple lenses, or may include a driving device capable of generating movement. According to an embodiment, the field of view may be adjusted through movement in the telephoto lens 320, but may be adjusted by directly moving the telephoto lens 320 including an actuator or the like. For example, the field of view may be adjusted through the movement of the telephoto lens 320 in the optical axis direction.

According to an embodiment, when the relative distance between the telephoto lens and the RGB camera increases, the field of view (FOV) of light reaching the object may decrease.

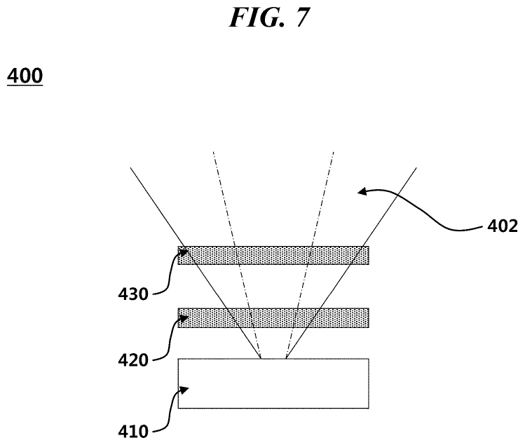

FIG. 7 illustrates a first embodiment of a distance measuring device.

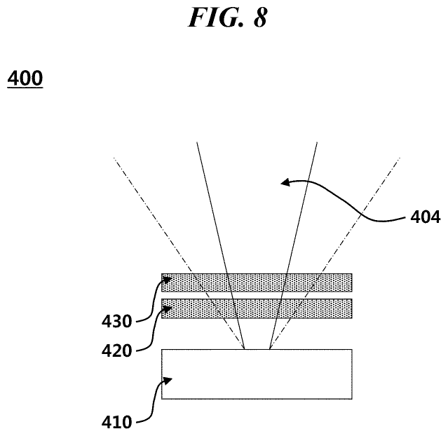

FIG. 8 illustrates a second embodiment of a distance measuring device.

Referring to FIGS. 7 and 8, a distance measuring device 400 may include a light source 410, a second diffusion device 420, and a first diffusion device 430.

The light source 410 may include at least one light source element. The light source element may be disposed with an independent region, and the intensity of light transferred from the light source element can be adjusted.

A light diffusion device may be a device through which light emitted from the light source passes, and may be divided into one or more regions.

The distance measuring device may adjust the field of view (FOV) of the distance measuring device on the basis of the relative distance between the second diffusion device 420 and the first diffusion device 430 and the relative movement thereof. The field of view (FOV) may be a first field of view 402 or a second field of view 404, and the first or second field of view may be distinguished based on a predetermined reference as necessary.

The first field of view and the second field of view may be defined based on the relative distance of the first diffusion device and the second diffusion device.

According to an embodiment, the distance measuring device illustrated in FIG. 1 or 2 may be used as the distance measuring device.

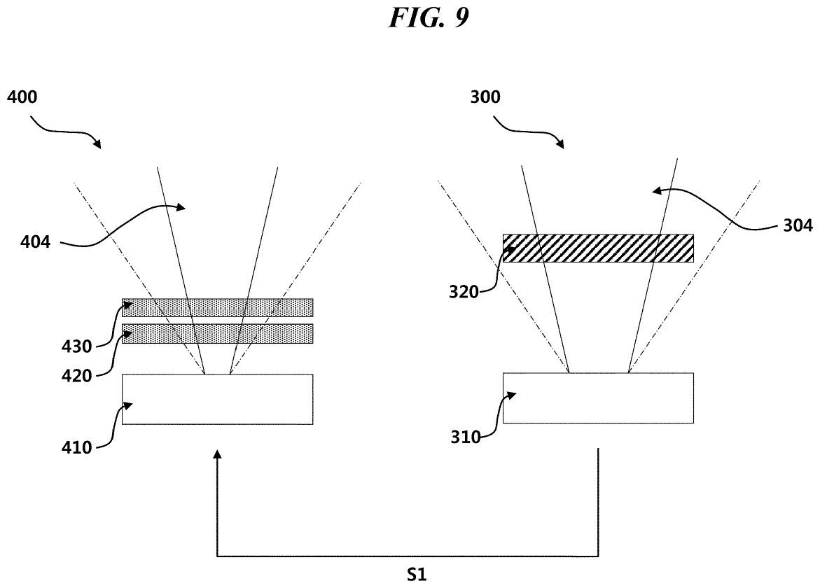

FIG. 9 illustrates the comparison of the field of view of a distance measuring device and the field of view of an RGB camera.

Referring to FIG. 9, the field of view of the RGB camera is compared with the field of view of the distance measuring device. For example, when the field of view (FOV) of the RGB camera is reduced by a telephoto lens, the FOV of the distance measuring device may be reduced in response to the reduction of the FOV of the RGB camera. This case may have an advantage of optimizing the light efficiency.

The field of view of the RGB camera and the field of view of the distance measuring device may be linked with each other and controlled such that the same amount of light can be received, thereby optimizing the light efficiency. In the process of linking and controlling Tx and Rx, a driving driver may be used, and a processor or a controller may be used as necessary.

The processor may generate movement of a light diffusion device or an actuator in response to the field of view (FOV) of the RGB camera, and may change the field of view of the RGB camera in response to the movement of the light diffusion device or the actuator. The processor may synchronize the distance measuring device in response to changing the field of view of the RGB camera, or may change the field of view of the RGB camera in response to the movement of the distance measuring device, and thus may maintain continuous operations of separate devices in real time.

Further, the distance measuring device may transfer a current generated during driving of the actuator to an image sensor in the distance measuring device to acquire distance data. Signals from a transmitter configured to output light and a receiver configured to sense light may be simultaneously controlled through an internal current.

The processor may measure a current or a voltage generated from interaction between the light diffusion device and the actuator to generate a signal for adjusting the field of view of the distance measuring device.

Further, the processor may acquire information about the field of view of the RGB camera, and may generate a signal for generating the movement of the actuator in response to the information about the field of view of the RGB camera.

Further, the processor may calculate the amount of a change in the field of view of the RGB camera, and may generate a signal for adjusting the movement distance of the light diffusion device in response to the amount of a change in the field of view of the RGB camera.

Further, in order to accurately calculate the movement distance of the light diffusion device, the processor may plot the movement of the actuator corresponding to the field of view of the RGB camera to form a lookup table, and may generate, based on the lookup table, a signal for changing the field of view of the RGB camera and/or the field of view of the distance measuring device.

Further, the processor may compare distance data measured by the distance measuring device with color image data measured by the RGB camera to generate three-dimensional data. When the three-dimensional data is generated by matching the distance data to the color image data for each position, three-dimensional map may be more elaborately aligned.

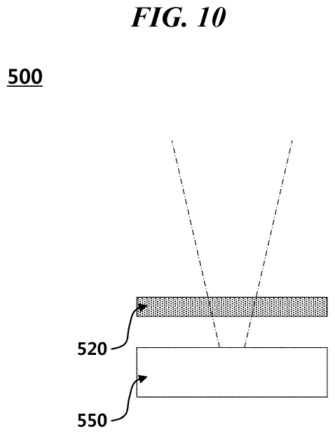

FIG. 10 illustrates a first embodiment of a second receiver of a distance measuring device.

Referring to FIG. 10, the second receiver 500 of the distance measuring device may be disposed in the distance measuring device, or may be separately disposed outside the distance measuring device. An optical device 520 may be used to adjust the region of light reaching the second receiver 500. The optical device 520 may be a concave lens, a convex lens, or a device capable of transferring or reflecting light, but is not limited thereto. The second receiver 500 of the distance measuring device may include an image sensor 550. The image sensor may be a charge-coupled device (CCD), a complementary metal-oxide-semiconductor (CMOS), or the like, but is not limited thereto.

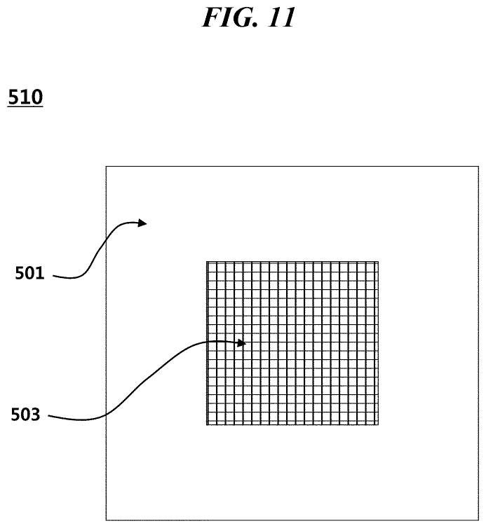

FIG. 11 illustrates a cross section of a second receiver of a distance measuring device.

Referring to FIG. 11, according to an embodiment, light may reach a partial region of the image sensor 550. A region 510 of the image sensor may be divided into a light-unreached region 501 and a light-reached region 503 according to whether light is reached.

According to a conventional technology, the field of view (FOV) of the distance measuring device is not synchronized, only a partial region of the center portion of the image sensor may be used. In this case, a method for cropping and using only a partial region of the center portion of an image (a cropping method) may be used, and thus the processing efficiency of the image sensor may be reduced.

When the field of view (FOV) of the distance measuring device according to one embodiment is synchronized, the entire region of the image sensor may be used.

According to an embodiment, distance data of the light-reached region 503 may be merged with or overlap a color data of an RGB camera. Data of a partial region of the second receiver 500 may be increased, and, in this case, the resolution of an image may be reduced. This is because the ratio of the amount of light for each pixel is reduced.

Further, noise may be generated by natural light at the periphery of the light-reached region 503, and a light leakage phenomenon may also occur.

The noise or the light leakage phenomenon may generate a difference between the data real image data, and, on the basis of a predetermined reference, the noise may be removed or a data error due to the light leakage phenomenon may be corrected. For example, regions having much noise may be measured and the noise may be selectively removed therefrom.

When three-dimensional data is generated by matching distance data measured by the distance measuring device to color image data measured by the RGB camera for each position, a more accurate three-dimensional data map may be drawn.

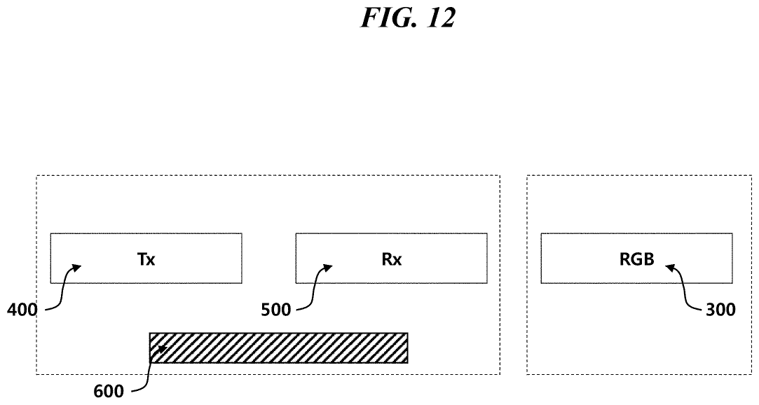

FIG. 12 illustrates a first embodiment of a control device.

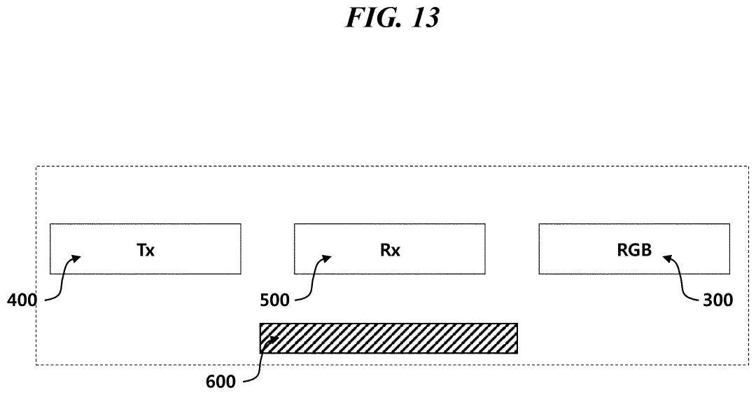

FIG. 13 illustrates a second embodiment of the control device.

Referring to FIGS. 12 and 13, according to an embodiment, a control device 600 may be included in a distance measuring device. According to another embodiment, the control device 600 may be included in all modules including a second transmitter and a second receiver of the distance measuring device. According to another embodiment, the control device 600 may be included in all modules including a distance measuring device and an RGB camera.

According to an embodiment, the control device 600 may control a signal of the RGB camera or the distance measuring device.

According to another embodiment, the control device 600 may calculate the field of view of the RGB camera, and may control the movement of the distance measuring device.

For example, a conventional control device, which may be called a driving processor, a driving driver, a driver IC, or the like, may be used as the control device 600.

The control device 600 (for example, the processor) may identify the field of view (FOV) of the red, green, and blue (RGB) camera, and adjust the field of view of the distance measuring device on the basis of a predetermined reference such that the field of view of the distance measuring device correspond to the field of view of the RGB camera.

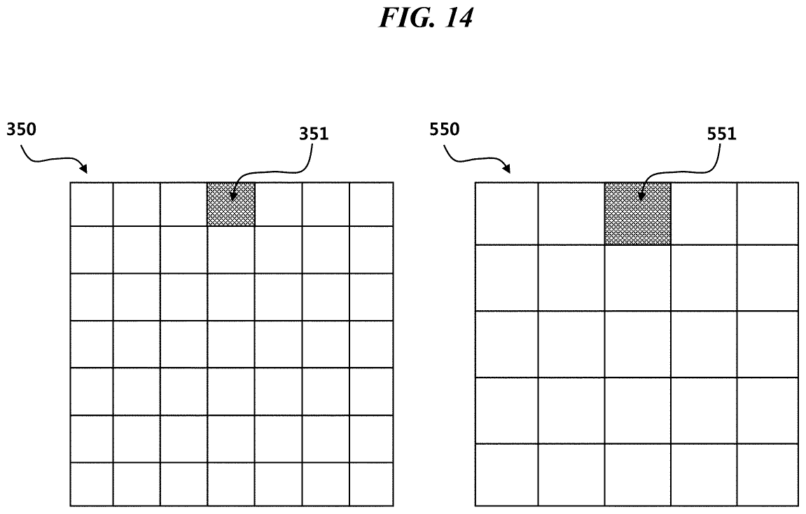

FIG. 14 illustrates the comparison of a first receiver region of an RGB camera and a second receiver region of a distance measuring device.

Referring to FIG. 14, a first receiver image sensor 350 of the RGB camera may be compared with a second receiver image sensor 550 of the distance measuring device.

Typically, the first receiver image sensor 350 of the RGB camera may use the entire area thereof. In contrast, in the second receiver image sensor 550 of the distance measuring device according to one embodiment, light may reach a partial region thereof, and the second receiver image sensor 550 of the distance measuring device may be compared with the image sensor of the RGB camera in order to be merged with or overlap the RGB camera. In this case, the resolution of depth information is reduced.

For example, a region 351 of the image sensor of the RGB camera has a higher-resolution image than a region 551 of the image sensor of the distance measuring device.

The difference between the ratios of the amount of light per pixel results in the difference between resolutions, and data of the image sensor of the RBG camera and data of the image sensor of the distance measuring device may be corrected and merged or may be compared and processed based on a predetermined reference. In the case of correcting and processing the measured data, an optical device such as a light diffusion device is not required in the second receiver image sensor 550 of the distance measuring device.

According to another embodiment, light reaching the image sensor may be adjusted in advance without correcting and merging or comparing and processing the measured data of the image sensor.

A telephoto lens or a light diffusion device (not shown) (for example, a concave lens or a convex lens) capable of changing the traveling path of light may be additionally installed in the second receiver image sensor 550 of the distance measuring device, thereby allowing light to reach the entire region of the second receiver image sensor 550 of the distance measuring device.

The light diffusion device (not shown) may adjust the focal length of reflected light transferred to the image sensor, thereby allowing light to reach the entire region of the second receiver image sensor.

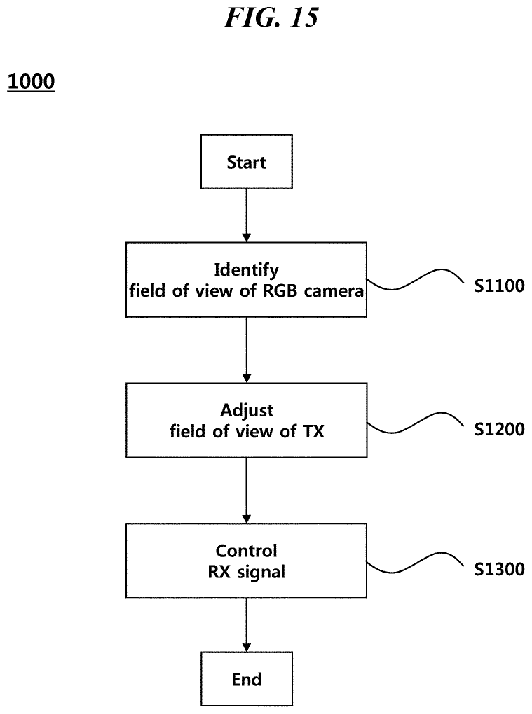

FIG. 15 is a flowchart illustrating a method for synchronizing the field of view of a distance measuring device.

Referring to FIG. 15, the method for synchronizing the field of view of the distance measuring device may include: identifying the field of view of an RGB camera (S1100); adjusting the field of view of Tx (S1200); and controlling a signal of Rx (S1300).

According to an embodiment, the distance measuring device 400 may include: a light source 410 including one or more light source elements; and a light diffusion device through which light emitted by the light source passes.

A method for synchronizing the field of view of the distance measuring device 400 may include: identifying the field of view (FOV) of a red, green, and blue (RGB) camera 300); and adjusting the field of view of the distance measuring device on the basis of a predetermined reference such that the field of view of the distance measuring device corresponds to the field of view of the RGB camera 300.

Further, the method may further include controlling a receiver signal on the basis of a current generated in the process of adjusting the field of view of the distance measuring device 400 so as to correspond to the field of view of the RGB camera 300. The current generated in the above-described process is considered to be a meaningful reference value in that the same can provide an accurate reference for synchronizing the distance measuring device and the RGB.

According to an embodiment, the field of view (FOV) of the distance measuring device 400 may be adjusted so as to correspond to the field of view (FOV) of the RGB camera 300, and synchronization between Tx and the RGB camera may be performed based on a current generated during relative movement between the light diffusion devices of the distance measuring device 400.

If necessary, the accuracy of adjusting the field of view (FOV) may be verified and calibrated based on the current generated during the relative movement of the distance measuring device.

For example, a transmitter and a receiver of the distance measuring device may be simultaneously or sequentially synchronized based on the intensity and waveform of a current generated through interaction between a coil and an electromagnet in an actuator. In this case, the distance measuring device may be synchronized with the RGB camera while synchronizing elements in the distance measuring device, and thus the accuracy and rapidity of data acquisition may be ensured.

For example, the relative movement of the distance measuring device corresponds to controlling the relative distance between a first diffusion device and a second diffusion device, and may be performed based on a current generated by a voice coil motor (VCM).

According to an embodiment, the RGB camera 300 may include a telephoto lens 320, and the field of view thereof may be adjusted by the telephoto lens.

A light diffusion device may be called a diffuser as necessary.

According to an embodiment, the light diffusion device may include a first diffuser and a second diffuser. The first diffuser may transmit light emitted by the light source and may be connected to a first support, and a body surrounding the first diffuser may be required.

The body may include a coil, a piezoelectric element, or a rotation device, and the first diffuser may interact with the body to generate movement in a direction of an optical path or in a direction perpendicular to the optical path. The first diffuser may include a magnet or a metal material, and the radiation angle or direction of light may be adjusted by the movement generated through the interaction between the first diffuser and the body.

According to an embodiment, the light source may receive a control signal and may separately adjust outputs of the light source elements.

Further, the method may further include measuring a current or a voltage generated from the interaction between the first diffuser and the body. The second receiver of the distance measuring device may be accurately controlled based on the current or the voltage.

According to an embodiment, the RGB camera may include a first transmitter and a first receiver, and the distance measuring device may include a second transmitter and a second receiver. The method may further include comparing a signal from the first receiver of the RGB camera with a signal from the second receiver of the distance measuring device, thereby more detailedly and accurately synchronizing the field of view of the distance measuring device 400.

Further, the method may further include selecting only a signal of a partial region of the second receiver of the distance measuring device 400. Through a method for processing a signal of the partial region, the resolution of an image may be increased or noise may be reduced.

According to an embodiment, the second receiver of the distance measuring device 400 may further include an optical device. The optical device may adjust a light-reaching region of the second receiver, the intensity of light, the distribution of light, etc. The type of optical device is not limited if the optical device is capable of transmitting or reflecting light.

What is claimed is:

1. A distance measuring device comprising:
a substrate;
a light source which is electrically connected to the substrate, wherein an intensity of light outputted from the light source is adjustable;
a light diffusion device configured to change an optical path of an output light from the light source; and
an actuator configured to make a spatial movement of the light diffusion device,
wherein the movement of the light diffusion device corresponds to a field of view (FOV) of an RGB camera.

2. The distance measuring device of claim 1, wherein a current generated while the actuator is driven is transferred to an image sensor in the distance measuring device to obtain distance data.

3. The distance measuring device of claim 1, wherein the RGB camera further comprises a telephoto lens and the field of view of the RGB camera is changed according to a movement of the telephoto lens.

4. The distance measuring device of claim 1, wherein the light diffusion device comprises a first light diffusion device and a second light diffusion device, wherein the first light diffusion device is connected to a first support fixed to the substrate and is configured to change the optical path of the output light and the second light diffusion device is configured to change a path of light transferred from the first light diffusion device,
the actuator comprises a coil, a piezoelectric element, or a rotation device,
the second light diffusion device comprises a magnet or a metal material which interacts with the actuator to make a movement in a direction of an optical path or in a direction perpendicular or parallel to the optical path, and
the movement made by the interaction between the second light diffusion device and the actuator allows adjusting a radiation angle or a direction of light.

5. The distance measuring device of claim 4, wherein the distance measuring device is configured to measure a current or a voltage generated from the interaction between the second light diffusion device and the actuator to adjust the field of view of the distance measuring device.

6. The distance measuring device of claim 1, further comprising a processor,
wherein the processor is configured to acquire information about the field of view of the RGB camera and to make a movement of the actuator depending on the information about the field of view of the RGB camera.

7. The distance measuring device of claim 6, wherein the processor is configured to control the field of view of the RGB camera and to calculate a movement distance of the light diffusion device and a field of view of the distance measuring device corresponding to the field of view of the RGB camera.

8. The distance measuring device of claim 6, wherein the processor is configured to calculate an amount of a change in the field of view of the RGB camera and to generate a distance control signal for adjusting the movement distance of the light diffusion device according to the amount of a change in the field of view of the RGB camera.

9. The distance measuring device of claim 1, further comprising an image sensor configured to receive reflected light from a subject to acquire distance data.

10. The distance measuring device of claim 6, wherein the processor is configured to compare data measured by an image sensor of the RGB camera with data measured by an image sensor of the distance measuring device to adjust the field of view of the distance measuring device.

11. The distance measuring device of claim 9, wherein the image sensor is configured to select data of only a partial region of the image sensor and to control the field of view of the distance measuring device.

12. The distance measuring device of claim 9, further comprising a light diffusion device configured to adjust a focal length of a lens through which the reflected light to be transferred to the image sensor passes.

13. The distance measuring device of claim 6, wherein the processor is configured to compare distance data measured by the distance measuring device with color image data measured by the RGB camera to generate three-dimensional data.

14. The distance measuring device of claim 13, wherein the processor is configured to match the distance data measured by the distance measuring device to the color image data measured by the RGB camera for each position to generate three-dimensional data.

15. A method for synchronizing a field of view of a distance measuring device comprising:
a light source comprising one or more light source elements; and
a light diffusion device through which light emitted from the light source passes,
wherein the light diffusion device is divided into one or more regions, each of the light source elements of the light source is disposed to have an independent region, and an intensity of light transferred from the light source elements is adjustable,
the method comprising:
identifying a field of view (FOV) of a red, green, and blue (RGB) camera; and
adjusting, based on a predetermined reference, the field of view of the distance measuring device such that the field of view of the distance measuring device corresponds to the field of view of the RGB camera.

16. The method of claim 15, further comprising transferring, to an image sensor, a current generated while the field of view of the distance measuring device is adjusted such that the field of view of the distance measuring device corresponds to the field of view of the RGB camera.

17. The method of claim 16, wherein the light diffusion device comprises a first light diffusion device and a second light diffusion device,
the first light diffusion device is configured to let light emitted from the light source pass and is connected to a first support,
the first light diffusion device is surrounded by a body,
the body comprises a coil or a piezoelectric element,
the first light diffusion device comprises a magnet or a metal material which interacts with the body to make a movement in a direction of an optical path or in a direction perpendicular to the optical path,
the movement made by the interaction between the first light diffusion device and the body allows adjusting a radiation angle or a direction of light, and
the light source is configured to respectively adjust output lights of the light source elements.

18. A system comprising:
an RGB camera configured to acquire two-dimensional data of a subject; and
a distance measuring device configured to acquire distance data of the subject,
wherein the distance measuring device comprises:
a light source configured to output light;
a light diffusion device configured to change a path of light transferred from the light source and to reduce an intensity of the light;
an actuator configured to make a movement of the light diffusion device through interaction between a coil and an electromagnet disposed therein; and
a processor configured to calculate a field of view of the RGB camera and/or a field of view of the distance measuring device to control a movement of the RGB camera and/or the distance measuring device.

19. The system of claim 18, wherein the light diffusion device comprises a first light diffusion device and a second light diffusion device and the actuator is configured to change a relative distance between the first light diffusion device and the second light diffusion device.

20. The system of claim 19, wherein the processor is configured to plot a movement of the actuator corresponding to the field of view of the RGB camera to form a lookup table and is configured to change the field of view of the distance measuring device based on the lookup table.
